(19) United States
(12) Patent Application Publication
(10) Pub. No.: US 2014/0164839 A1
(43) Pub. Date: Jun. 12, 2014

(54) PROGRAMMABLE DEVICE, METHOD FOR RECONFIGURING PROGRAMMABLE DEVICE, AND ELECTRONIC DEVICE

(71) Applicants: Tadanobu Toba, Tokyo (JP); Kenichi Shimbo, Tokyo (JP)

(72) Inventors: Tadanobu Toba, Tokyo (JP); Kenichi Shimbo, Tokyo (JP)

(21) Appl. No.: 14/232,930

(22) PCT Filed: Jun. 25, 2012
(86) PCT No.: PCT/JP2012/066101

§ 371 Date: Jan. 15, 2014

(30) Foreign Application Priority Data
Aug. 24, 2011 (JP) 2011-182103

(51) Int. Cl. G06F 11/07

(52) U.S. Cl. CPC G06F 11/079
USPC 714/37

(57) ABSTRACT

In the event of a software error, operations of a programmable device must be suspended while a configuration memory is being rewritten; however, with a system such as a communication device that will be significantly affected if the device is shut down, the system needs to be restored without suspending the operations. This programmable device is provided with: multiple control circuits; a comparison unit that compares outputs of the multiple control circuits so as to inspect for an occurrence of an error; a storage unit that stores internal states of error-free control circuits among the multiple control circuits when an occurrence of an error is determined by the comparison unit; a reconfiguration unit that reconfigures the control circuit in which the occurrence of the error has been determined by the comparison unit; and a control unit that inputs the internal states of the error-free control circuits, which are stored in the storage unit, to the control circuit in which the occurrence of the error has been determined by the comparison unit.

### TECHNICAL FIELD

The present invention relates to reliability improvement of the whole of electronic devices. In particular, the present invention relates to a programmable device, a method for reconfiguring a programmable device, and an electronic device.

### BACKGROUND ART

With size shrinking of semiconductor devices, the problem of soft errors caused by environmental radiations is actualized especially for SRAMs (non patent literature 1), logic gates (non patent literature 2), clock systems (non patent literature 3), and the like. If a neutron having extremely high energy rushes into an atomic nucleus included in a device, nucleons (neutrons, protons) in the nucleus repeat collision and nucleons having especially high energy are emitted to the outside of the nucleus. If a state in which nucleons cannot have kinetic energy enough to fly out to the outside of the nucleus is brought about, a process in which protons, neutrons, deuterons, and leptons such as alpha particles evaporate from a remaining atomic nucleus in an excited state continues. Finally, the remaining nucleus also has recoil energy. Therefore, all of these secondary particles fly in the device by distances corresponding to their ranges.

If alpha rays generated from radioisotope included in a semiconductor package or the like or secondary ions having charge generated as a result of a nuclear reaction pass through a vacancy layer in a storage node, electrons are absorbed by the node and holes flow in an opposite direction and a charge collection area spreads along a track of ions. Charges are collected into the storage node by this funneling mechanism. If charges of a critical charge amount or more are collected, a “high” state shifts to a “low” state, resulting in a soft error (Single Event Upset; SEU).

This is a typical mechanism which has been considered as a mechanism of an environmental radiation soft error, and it is called SEU (Single Event Upset). As for the SEU of a memory device, a case where a plurality of cells become erroneous at the same time is called MCU (Multi Cell Upset), and it is distinguished from SBU (Single Bit Upset; single bit error). In a case where MCU occurs in the same word, it is called MBU (Multiple Bit Upset) and it cannot be restored by using an ordinary ECC (Error Correction Code), resulting in a cause of system down.

As for soft errors including the SEU, update to new data is conducted even after occurrence of an error and restoration to a normal state is performed by restart or the like, unlike a hard error (a fixed failure in hardware). This results in a problem that it is difficult to find a cause of the error. In this way, influence of a soft error occurring in a logic circuit means that false operations are caused in a processor in a computer, an ASIC, a digital circuit for control, or the like. There is a fear that the soft error will cause a false operation in an electronic system.

In recent years, programmable devices have been frequently used as control logic circuits in various electronic system devices. Especially among the programmable devices, utilization of FPGA (Field Programmable Gate Array) is increasing. In the FPGA, logic circuit information is stored in a memory (configuration memory: configuration will be “config” for short) within a device and arithmetic operation circuits or control circuits are constructed. There is a possibility that a false operation of an electronic system device will be caused due to destruction of data stored in the memory by a soft error. It is becoming regarded as a problem. Usually, consideration is given to prevent the system from being affected by a false operation. However, this becomes a cause of an increase in power dissipation, development work, verification work, and cost.

As attempts to improve tolerance of the FPGA to environmental radiations, there are a technique using reconfiguration (“reconfig” for short) to write proper circuit information again into a configuration memory rewritten by a soft error, and a technique using internal circuits provided with redundancy and a majority decision circuit. Patent literature 1 (JP-A-2011-13829) discloses improvement of tolerance by reconfiguring a circuit region where a soft error has occurred, and shortening of time from occurrence of a soft error to completion of reconfiguration by storing circuit information using fixed length blocks, conducting soft error detection by taking a fixed length block as the unit, and providing a means for reconfiguring only the circuit region. Patent literature 2 (JP-B-4422596) discloses an attempt to achieve high reliability by disposing at least two reconfigurable signal processing systems dispersedly in various signal processing units connected by a network and substituting a different reconfigurable signal processing system which can perform a normal operation for a signal processing unit in which a failure (including a soft error) has occurred. Furthermore, non patent literature 4 describes a tolerant circuit technique. According to the tolerant circuit technique, triplication (TMR: Triple Modular Redundant) is performed for a processor circuit in a FPGA. In a case where a configuration memory is rewritten because of a soft error, operation of the whole inclusive of a normally operating processor circuit is stopped once and an internal register of a normal circuit is stored in an internal memory. Then, only the processor circuit is reconfigured. After the reconfiguration is finished, the stored register values are loaded into the reconfigured processor circuit. Thereafter, restoration is performed by conducting restart.

### CITATION LIST

### Patent Literature

PATENT LITERATURE 1: JP-A-2011-13829
PATENT LITERATURE 2: JP-B-4422596

### Non Patent Literature

NON PATENT LITERATURE 1: E. Ibe, “Current and Future trend on Cosmic-Ray-Neutron Induced Single Event Upset at the Ground down to 0.1-Micron-Devices,” The Svedberg Laboratory Workshop on Applied Physics, Uppsala, May 3, No. 1 (2001).
NON PATENT LITERATURE 2: P. Shivakumar (University of Texas at Austin), W. Kistler, W. Keckler. S, DougBurger, Lorenzo. A., “Modeling the Effect of Technology Trends on the Soft Error Rate of Combinational Logic,” Int'l Conf. on Dependable Systems and Networks, pp. 389-398 (2002).
NON PATENT LITERATURE 3: Seifert, N., Shipley, Pant, M. D., Ambrose, V, and Gill, B., “Radiation-Induced Clock Jitter and Race,” 2005 IEEE International Reliability Physics Symposium Proceedings, April 17-21, San Jose, Apr. 17-21, 2005, Vol. 43rd Annual, pp. 215-222 (2005).
NON PATENT LITERATURE 4: Improving the Robustness of a Softcore Processor against SEUs by using TMR and Partial Reconfiguration, author name: Yoshihiro Ichinomiya, Shiro Tanoue (Kumamoto University), document name: 2010 18th Annual International Symposium on Field-Programmable Custom Computing Machines.

### SUMMARY OF INVENTION

### Technical Problem

As sizes of semiconductor devices shrink and reliability of the semiconductor devices becomes high, influence of soft errors caused by environmental radiations (such as alpha rays and neutron rays) spreads and soft error frequencies in programmable devices (mainly FPGAs) increase rapidly. As a result, soft errors in electronic system products are posing a problem. However, it is difficult to shield neutron rays which are a main cause of soft errors, and it is difficult to provide a countermeasure against soft errors.

As a method for improving tolerance against soft errors in programmable devices, it is general to make a circuit redundant. If a part of a redundant circuit is rewritten by neutrons, however, an error remains as long as the region is not rewritten with correct data, resulting in hampered redundancy. In this case, restoration is possible by partially rewriting the whole programmable device or a region where an error has occurred. Unless operation is stopped inclusive of a normal circuit while rewriting is performed, a difference occurs in processing speed between processing in the normal circuit and processing in a circuit in which the error has occurred. In a case where a configuration memory is rewritten when a soft error has occurred in a programmable device, therefore, the operation must be stopped during that time. In a system, such as a communication device, in which device stopping exerts great influence, it is important to perform restoration without stopping the operation of the system. When using a programmable device, therefore, the soft error was coped with formerly by making the whole product or a part of the product (such as a substrate unit) redundant.

An object of the present invention is to improve tolerance of a programmable device used in an electronic system product to environmental radiation soft errors and provide a programmable device, a method for reconfiguring a programmable device, and an electronic device capable of contributing to implementation of high reliability and a non-stopping system required of a social infrastructure system.

### Solution to Problem

Among aspects of the invention disclosed in the present application, an outline of a representative aspect will now be described briefly.

(1) A programmable device includes a plurality of control circuits, a comparison unit for comparing outputs from the plurality of control circuits and inspecting occurrence of an error, a storage unit responsive to determination that an error has occurred therein conducted by the comparison unit to store an internal state of a control circuit in which an error has not occurred among the plurality of control circuits, a reconfiguration unit for reconfiguring a control circuit determined that an error has occurred therein by the comparison unit, and a control unit for inputting the internal state of the control circuit in which an error has not occurred, stored in the storage unit, to the control circuit determined that an error has occurred therein by the comparison unit.

### Advantageous Effects of Invention

According to the present invention, it is possible to improve tolerance of a programmable device used in an electronic system product to environmental radiation soft errors and provide a programmable device, a method for reconfiguring a programmable device, and an electronic device capable of contributing to implementation of high reliability and a non-stopping system required of a social infrastructure system.

### BRIEF DESCRIPTION OF DRAWINGS

FIG. 1 is a configuration diagram of a programmable device according to an embodiment of the present invention;

FIG. 2 is another configuration diagram of a programmable device according to an embodiment of the present invention;

FIG. 3 shows an operation sequence example according to an embodiment of the present invention;

FIG. 4 is a diagram showing a timing chart example of control on a redundant region exercised by a programmable device according to an embodiment of the present invention;

FIG. 5 is a diagram showing a means used to record an internal state of a redundant region by a programmable device according to an embodiment of the present invention;

FIG. 6 is a diagram showing an input screen example in a case where design is conducted on the basis of a programmable device according to an embodiment of the present invention;

FIG. 7 is a diagram showing a means for forcibly inserting a soft error when conducting verification on design including a region configured by a programmable device according to an embodiment of the present invention;

FIG. 8 is a diagram showing a means for outputting an internal state to the outside at time of environmental radiation irradiation test on an electronic system device using a programmable device according to an embodiment of the present invention;

FIG. 9 shows an example of a screen that displays an output result obtained in FIG. 8;

FIG. 10 shows a configuration example of a reconfiguration control unit formed by a programmable device according to an embodiment of the present invention and a high order system; and

FIG. 11 shows an example in which a communication device according to an embodiment of the present invention is configured.

### DESCRIPTION OF EMBODIMENTS

An example of a circuit and a device tolerant to a soft error caused by environmental radiations in a programmable device according to the present invention will now be described with reference to the drawings.

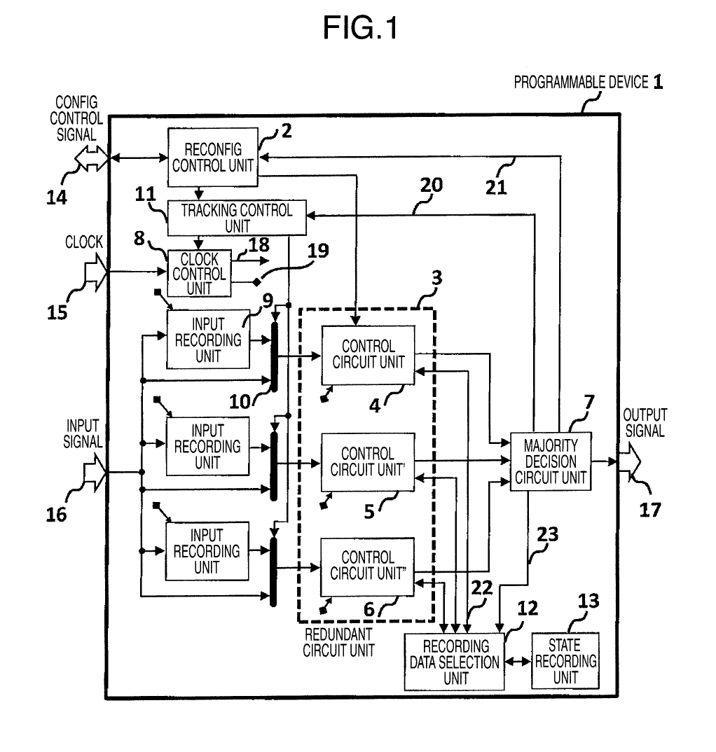

FIG. 1 is a configuration diagram of a programmable device programmable device according to an embodiment of the present invention.

A programmable device 1 shown in FIG. 1 includes a reconfiguration control unit 2, a redundant circuit unit 3 (control circuit units 4, 5 and 6), a majority decision circuit unit 7, a clock control unit 8, input recording units 9, selectors 10, a tracking control unit 11, a recording data selection unit 12, and a state recording unit 13.

The control circuit units 4, 5 and 6 are circuits for implementing desired functions such as various arithmetic operations, external memory control, communication packet analysis processing, and external I/F control. The control circuit units 4, 5 and 6 receive signals selected by the selectors 10, and output data of the control circuit units 4, 5 and 6 are output to the majority decision circuit unit 7. The control circuit units 5 and 6 are duplicates of the control circuit unit 4, and the control circuit units 5 and 6 have redundancy. Here, the control circuit units 4, 5 and 6 are collectively referred to as redundant circuit unit 3.

The clock control unit 8 receives a clock signal 15 from the outside and outputs a clock signal 18 having a frequency used in a steady state or a clock signal 19 changed in frequency to regions such as the control circuit units 4, 5 and 6, the reconfiguration unit 2, the majority decision circuit unit 7, the input recording units 9, the tracking control unit 11, the recording data selection unit 12, and the state recording unit 13.

The majority decision circuit unit 7 conducts majority decision processing on the output data of the control circuit units 4, 5 and 6 in order to improve the tolerance to environmental radiations, determines whether a soft error occurs, or identifies a control circuit unit in which a soft error occurs. Upon determining that an error occurs in one of the control circuit units 4, 5 and 6, the majority decision circuit unit 7 sends signals 20, 21 and 23 informing that an error has occurred to the tracking control unit 11, the reconfiguration control unit 2 and the recording data selection unit 12, respectively. Furthermore, the majority decision circuit unit 7 outputs a result of the decision to the outside as an output signal 17.

The recording data selection unit 12 selects normal control circuit units in which an error does not occur at the time when the soft error has occurred, on the basis of the decision result in the majority decision circuit unit 7 as to whether a soft error has occurred, and exchanges a signal 22 informing of internal state data with the selected control circuit units 4, 5 and 6.

The state recording unit 13 conducts data exchange with the recording data selection unit 12, and stores an internal state of the normal control circuit unit in which an error has not occurred and which is selected by the recording data selection unit 12.

The reconfiguration control unit 2 receives the signal 21 informing of error occurrence from the majority decision circuit unit 7, and exchanges a configuration control signal 14 with the outside. As a result, the reconfiguration control unit 2 exercises write control into a configuration memory (not disclosed) provided in the programmable device to store circuit information for implementing a desired function. The configuration memory is a memory indispensable to implement the programmable device, and it is used generally. All regions disclosed in FIG. 1 are stored in the configuration memory to implement the circuit function.

The input recording units 9 temporarily record an input signal 16 sent from the outside to be input to the control circuit units 4, 5 and 6, and outputs the input signal 16 to the selectors 10.

The selectors 10 select either the input signal 16 or the output signal from the input recording unit 9, and input the selected signal to the control circuit units 4 to 6.

On the basis of the signal 20 sent from the majority decision circuit unit 7 to inform that an error has occurred in a part of a control circuit and an output signal from the reconfiguration control unit 3, the tracking control unit 11 outputs a clock signal quickened temporarily and inputs the clock signal to the clock control unit 8 in order to make partial processing fast. Furthermore, the tracking control unit 11 outputs a signal which orders selection of an output signal to the selectors 10.

By the way, the redundant circuit unit 3 includes three control circuit units 4 to 6. However, a redundant configuration of at least triplication may be used. Redundancy becomes high by increasing the number of control circuit units. Furthermore, the clock control unit 8 has a means for changing the frequency and a means for distributing to a plurality of clock signals.

In the configuration of the programmable device 1 shown in FIG. 1, the configuration control signal 14 includes a signal for controlling circuit information data and writing, a signal informing that reconfiguration has finished, and a signal informing that the data is data in a region in the redundant circuit unit 3 where a soft error has occurred.

Furthermore, relating control units are informed that a soft error has occurred in a part of the control circuit by using the signal 20 sent from the majority decision circuit unit 7 to the tracking control unit 11 to inform that an error has occurred in a part of the control circuit, the signal 21 sent from the majority decision circuit unit 7 to the reconfiguration control unit 2 to inform that an error has occurred in a part of the control circuit, and the signal 23 sent from the majority decision circuit unit 7 to the recording data selection unit 12 to inform that an error has occurred in a part of the control circuit. Furthermore, after receiving the signal 20, the tracking control unit 11 informs the clock control unit 8 of occurrence of an error in the same way, and delivers information specifying a region for which the frequency should be changed among clock signals distributed within the programmable device 1, to the clock control unit 8.

By the way, a configuration in which this signal is input to the clock control unit 8 directly from the majority decision circuit unit 7 may be used. Although connections of clock signals are not shown in FIG. 1, the clock signal is connected to respective regions and the clock signal 19 is connected to the redundant circuit unit 3 and the input recording unit 9. Furthermore, since unnecessary data are sent to the majority decision circuit 7 at the time of reconfiguration, a function of masking inputs from the control circuit units to the majority decision circuit unit 7 may be provided in the majority decision circuit unit 7.

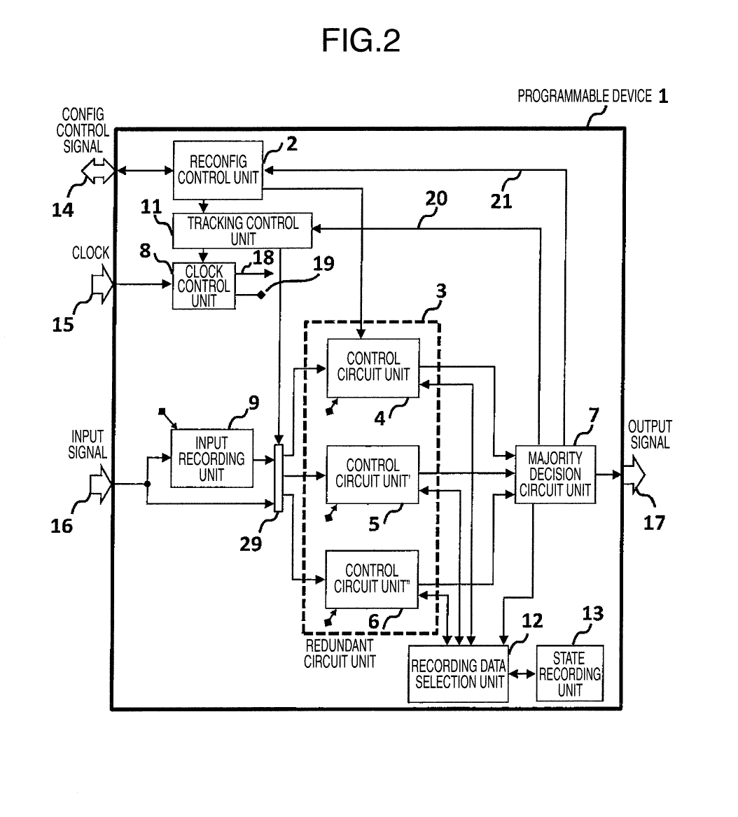

FIG. 2 shows another configuration example of a programmable device according to an embodiment of the present invention. The programmable device shown in FIG. 2 differs from the programmable device shown in FIG. 1 in that the input recording units 9 which are separate configurations in the programmable device shown in FIG. 1 are collected to one configuration. In FIG. 1, as many input recording units 9 as the number of redundant control circuit units in the redundant circuit unit 3 (three input recording units 9) are included. In the configuration shown in FIG. 2, data of the input signal 16 is always stored in the input recording unit 9 as well. In a case where a soft error has occurred, a bus selector 29 selects a signal that is not passed through the input recording unit 9, for normal control circuit units in which the soft error has not occurred. As an input signal to a control circuit unit in which reconfiguration is finished, the bus selector 29 selects a signal passed through the input recording unit 9. Owing to this configuration, the volume of the input recording unit 9 can be reduced.

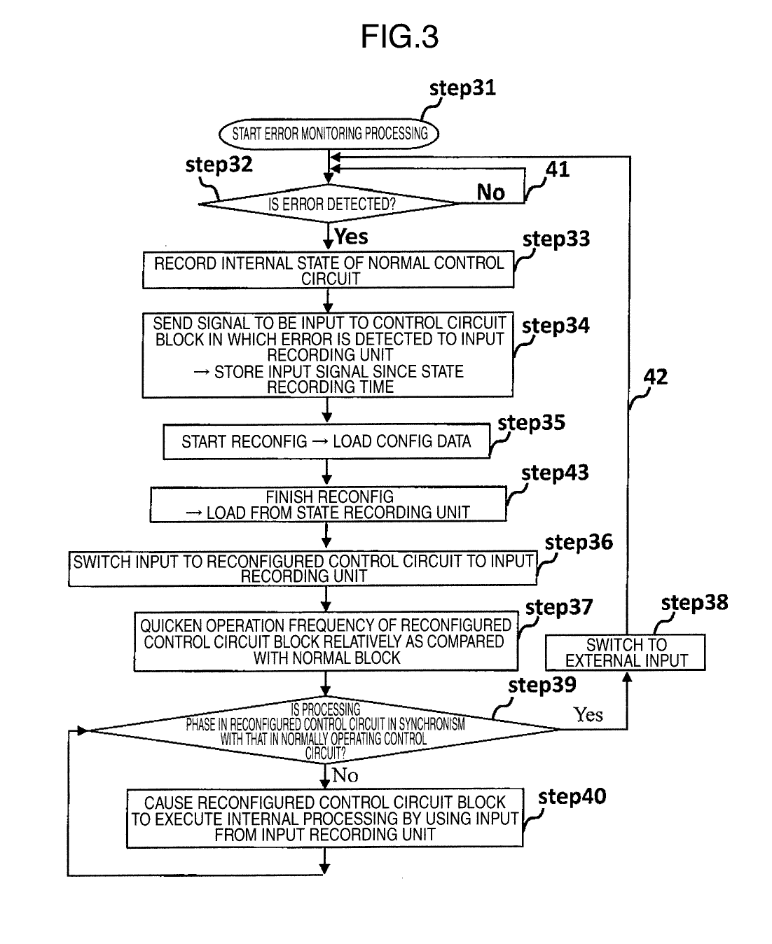

FIG. 3 shows an operation sequence example according to an embodiment of the present invention.

The control circuit units 4, 5 and 6 are formed by circuits having a desired function. After the control circuit starts a steady state operation, the majority decision circuit unit 7 starts soft error monitoring processing on the basis of outputs of the control circuit units 4 to 6 (step 31). By the way, the soft error may be detected not only by the majority decision circuit unit 7 but also by a means for monitoring data inversion in the configuration memory in the programmable device.

In a case where a soft error is detected at the step 31 (Yes at step 32), the recording data selection unit 12 selects a normal control circuit unit on the basis of a detection result in the majority decision circuit unit 7 and stores an internal state of the normal control circuit unit into the state recording unit 13 (step 33). The internal state means a status register, for example, in a case where the control circuit unit is a processor. Unless a soft error is detected at the step 31 (No at the step 32), the error monitoring processing is continued successively until an error is detected.

Subsequently, a signal that is input to a control circuit block in which a soft error is detected is stored in the input recording unit 9 (step 34).

Subsequently, a reconfiguration operation in the control circuit unit in which a soft error is detected is started (step 35). After the reconfiguration is finished, state data at the time when operation is stopped is loaded from the state recording unit 13 (step 43).

Thereafter, the input to the reconfigured control circuit is switched to the input side from the input recording unit 9 (step 36). The clock control unit 8 switches an operation frequency of the reconfigured control circuit unit (step 37).

The reconfigured control circuit unit continues operation by using the input signal from the input recording unit 9 until the reconfigured control circuit unit catches up with a processing phase in the normal control circuit unit (step 39, step 40).

In a case where it is determined that the reconfigured control circuit unit catches up with a processing phase in the normal control circuit unit, the selector 10 switches to the input signal from the outside (step 38).

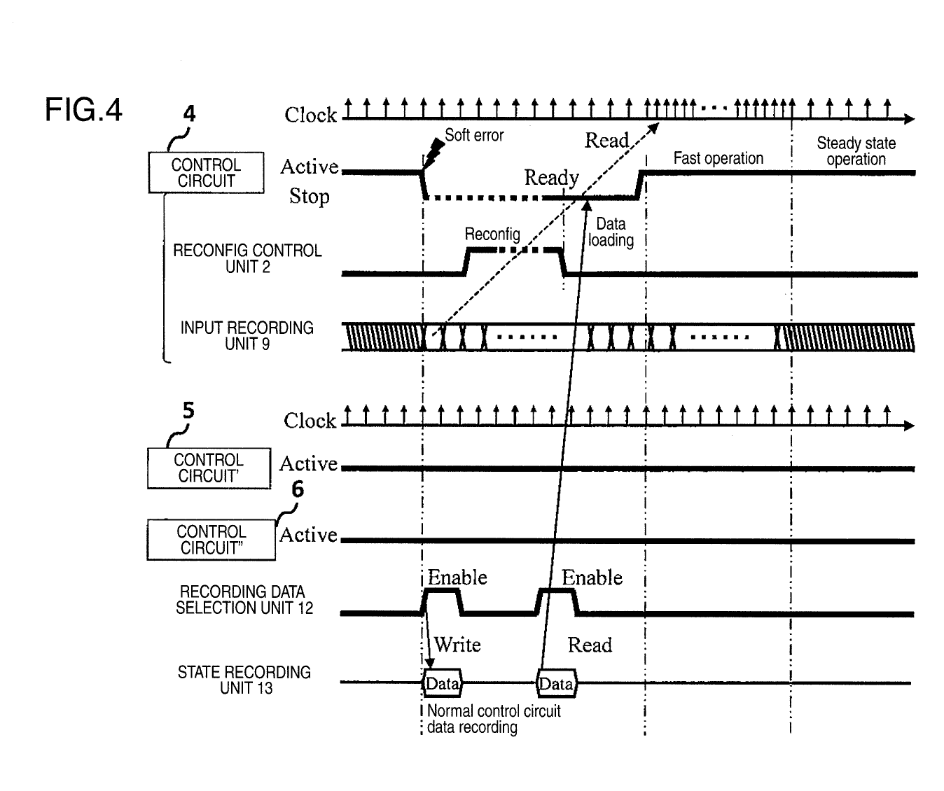

FIG. 4 is a diagram showing a timing chart example of control on a redundant region exercised by a programmable device according to an embodiment of the present invention.

An example in FIG. 4 shows a case where a soft error has occurred in the control circuit unit 4. When a soft error has occurred in the control circuit unit 4, the recording data selection unit 13 issues an operation start (illustrated enable state). Upon receiving this signal, the state recording unit 13 stores the internal state of the normal control circuit unit 5 or 6. At the same time, recording of the input signal 16 into the input recording units 9 is started. After the recording in the state recording unit 13 is completed, reconfiguration in the control circuit unit 4 is started. After the reconfiguration is completed, the operation frequency of the control circuit unit 4 is quickened as compared with the control circuit unit 5 and the control circuit unit 6. By the way, the control circuit units 5 and 6 may be made slow as compared with the control circuit unit 4.

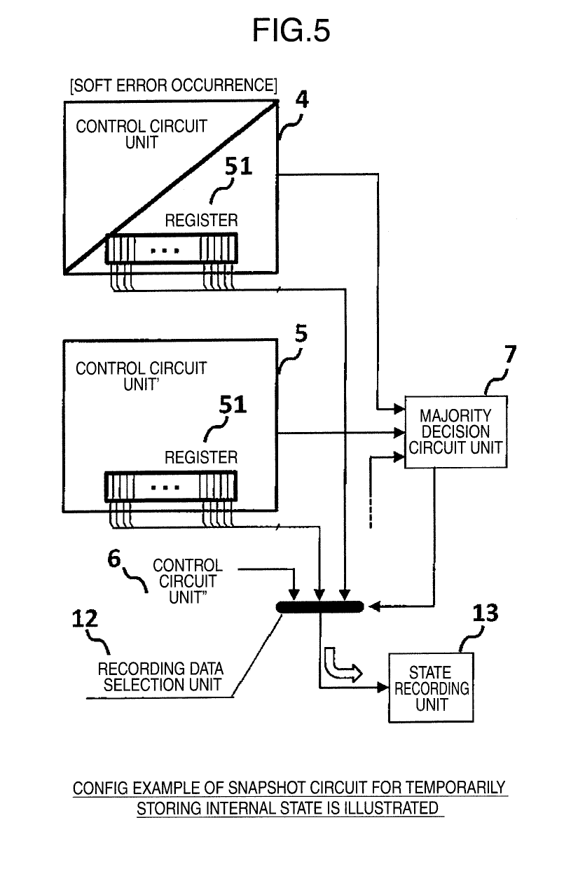

FIG. 5 is a diagram showing a means used to record an internal state of a redundant region by a programmable device according to an embodiment of the present invention. In an example shown in FIG. 5, the majority decision circuit unit 7 detects a soft error which has occurred in the control circuit 4, and conveys soft error detection information and a soft error occurrence region to the recording data selection unit 12. The recording data selection unit 12 duplicates data in a register 51 which retains an internal state of a normal control circuit unit (in FIG. 5, the control circuit unit 5 or 6), into the state recording unit 13 collectively. In a case where there are a plurality of normal control circuit units, a priority determination method for the selection does not matter especially.

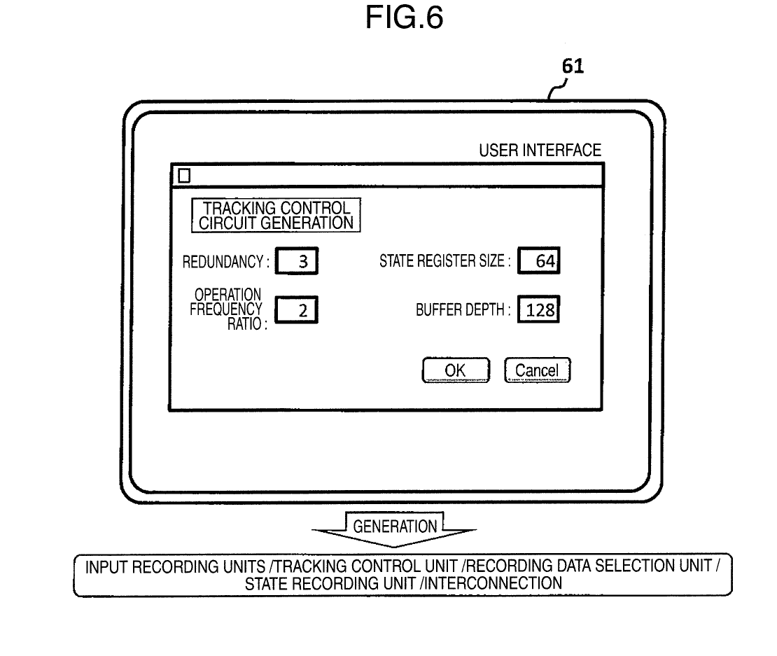

FIG. 6 is a diagram showing an example of an input (GUI) 61 in a case where design is conducted on the basis of a programmable device according to an embodiment of the present invention.

In a program having a function of adding a circuit configuration according to the present invention to the control circuit units 4 to 6 to form a desired function in the programmable device 1, it is possible to input on its input screen, redundancy which represents the number of redundant control circuit units, an operation frequency ratio between a control circuit unit in which a soft error has occurred and control circuit units in which a soft error has not occurred, a state register size which represents a recording storage size in the state recording unit 13, and a buffer depth which represents a size for recording the input signal of the input recording units 9. This GUI screen has a function of generating the input recording units 9, the selectors 10, the tracking control unit 11, the recording data selection unit 12, the state recording unit 13, and connection information among them.

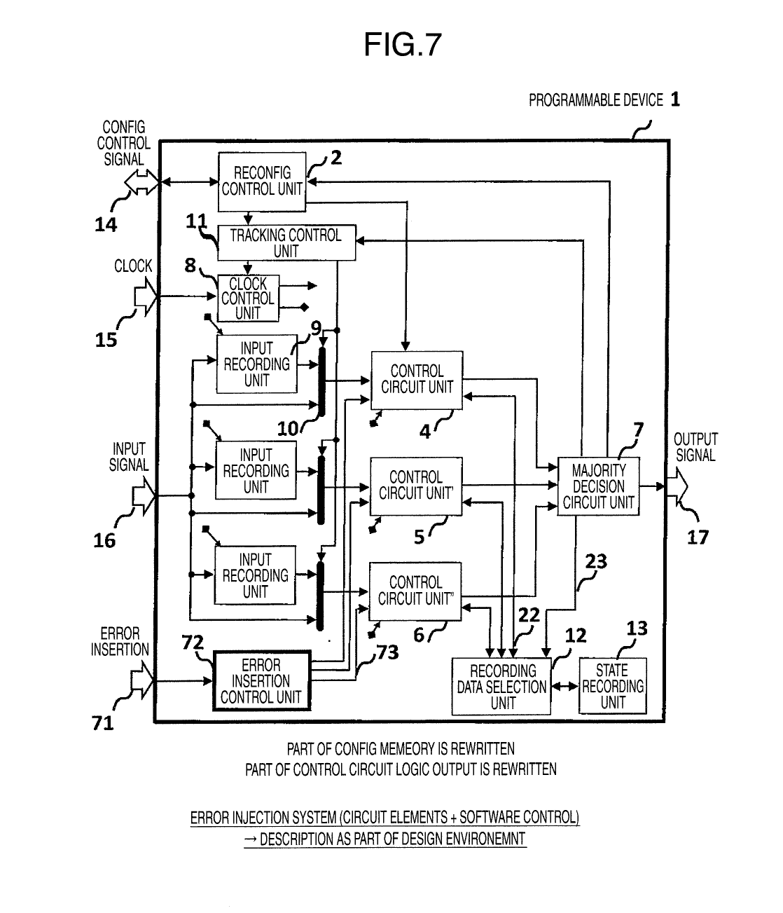

FIG. 7 is a diagram showing a means for forcibly inserting a soft error when conducting verification on design including a region configured by a programmable device according to an embodiment of the present invention. The programmable device shown in FIG. 7 differs from the programmable devices shown in FIG. 1 and FIG. 2 in that an error insertion control unit 72 is provided to forcibly cause a soft error at the time of verification on design of a programmable device according to the present invention and confirm operation from soft error detection to restoration. After receiving an error insertion signal 71 from the outside of the programmable device 1, the error insertion control unit 72 inserts an error to the control circuit units 4 to 6. An error insertion region is determined on the basis of the error insertion signal 71. By the way, as for the designation of the error insertion region, the error insertion region may be predetermined and incorporated when designing the circuit of the programmable device 1. Furthermore, the error insertion control unit 72 may invert data stored in a configuration memory in a control circuit unit that becomes an object.

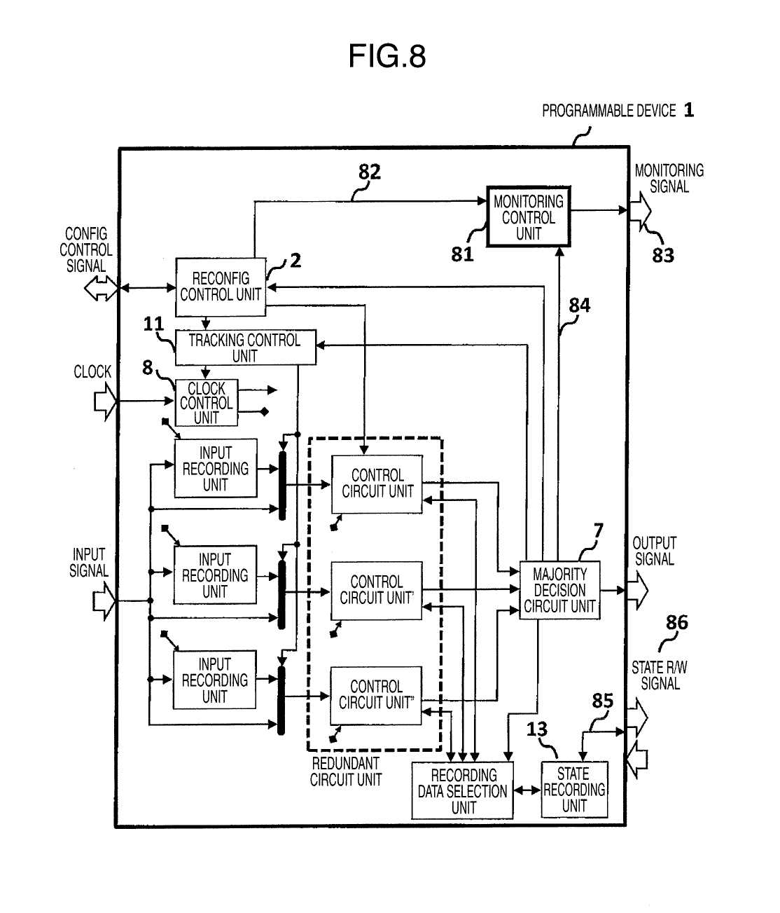

FIG. 8 is a diagram showing a means for outputting an internal state to the outside at time of environmental radiation irradiation test on an electronic system device using a programmable device according to an embodiment of the present invention. In the programmable device 1 according to the present invention, a monitoring control unit 81 and a means 85 for reading out stored data from the state recording unit 13 are provided. A soft error detection signal 84 from the majority decision circuit unit 7 is input to the monitoring control unit 81. Furthermore, a signal 82 which indicates a reconfiguration end state from the reconfiguration control unit 2 is input to the monitoring control unit 81 at the time of start of reconfiguration and during the reconfiguration. Upon receiving these inputs, the monitoring control unit 81 outputs a soft error detection state and a reconfiguration state by outputting a monitoring signal 83 to the outside at an environmental radiation tolerance test.

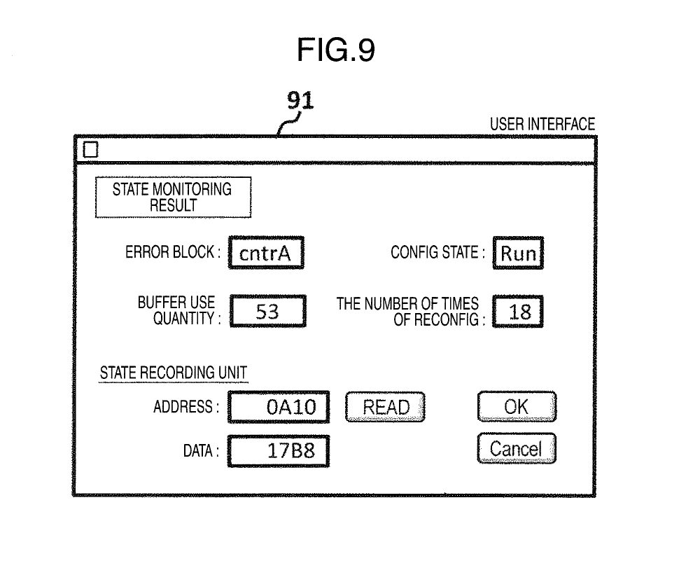

FIG. 9 shows an example 91 of a screen that displays an output result obtained in FIG. 8. An example in which information output by the monitoring means shown in FIG. 8 is displayed (GUI) by using an external computer or the like is shown in FIG. 9. As for displayed information, an error block representing a region in which a soft error has been detected, a buffer use quantity representing a use quantity of the input signal recording units 9, a configuration state representing a reconfiguration state, and the number of times of reconfiguration are displayed. Furthermore, an address representing a storage location at the time when reading out data stored in the state recording unit 13, and a data display part representing a result which is read out are included. Owing to this display screen, tolerance evaluation and operation confirmation can be performed easily at the time of a test in which environmental radiations are forcibly given. As for the buffer use quantity, the internal monitoring state is displayed immediately in some cases and a maximum use quantity of the buffer is displayed in other cases. By the way, the present configuration can also cope with a false operation cause analysis in ordinary product use state.

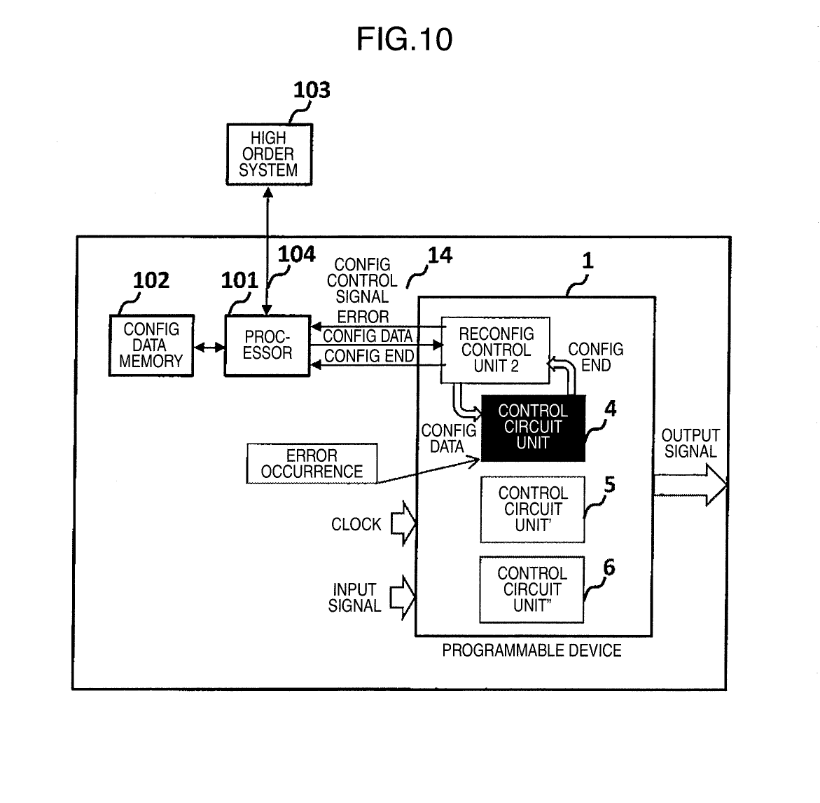

FIG. 10 shows a configuration example of a reconfiguration control unit formed by a programmable device according to an embodiment of the present invention and a high order system. Reconfiguration control in the programmable device 1 is exercised by an external processor 101. Upon detecting occurrence of a soft error, the reconfiguration control unit 2 conveys the error detection to the processor 101. The processor 101 reads out configuration data which is normal circuit information from the configuration data memory 102 storing configuration data, and reconfigures the programmable device 1. The reconfiguration control unit 2 monitors the reconfiguration state. After the reconfiguration is completed, the reconfiguration control unit 2 outputs a reconfiguration end signal to the processor 101. Furthermore, a configuration in which the configuration data 104 is input not from the configuration data memory 102 but from a high order system 103 (such as a computer) connected via a network or the like to conduct reconfiguration may be used.

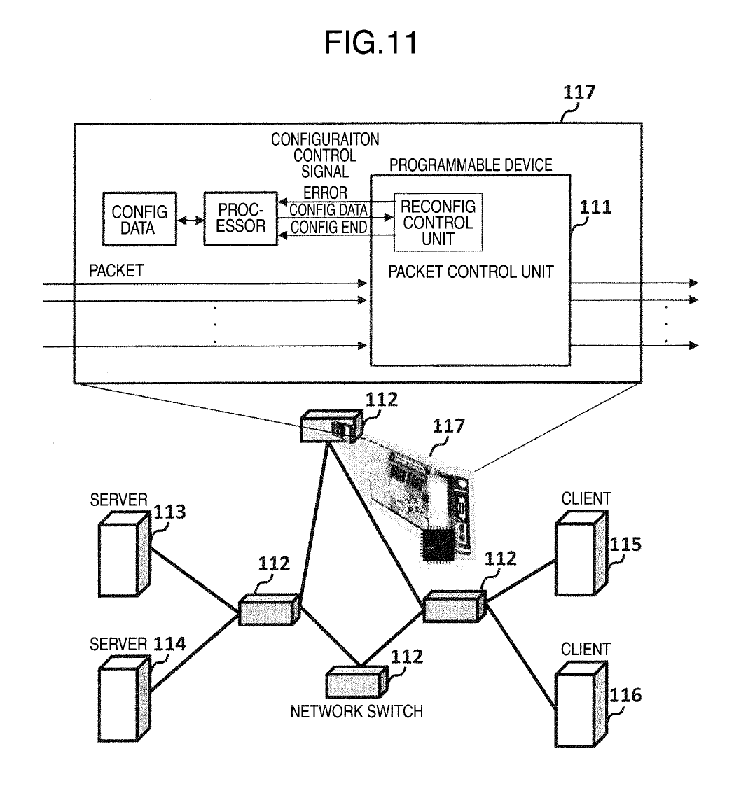

FIG. 11 shows an example in which a communication device according to an embodiment of the present invention is configured. In FIG. 11, an example in which a packet control unit 111 on a control substrate 117 mounted on a communication apparatus is implemented by using a programmable device according to the present invention is shown. In a network in which servers 113 and 114 are connected to client devices such as personal computers via network switches 112 having the packet control unit 111, the packet control unit 111 which conducts a path change for communication packets in the communication apparatus needs to let fast flowing packets flow continuously and is not allowed to stop.

By the way, an error detection means for the configuration memory also monitors units other than the control circuit units made redundant because there is a fear that a soft error will be caused by environmental radiations.

Furthermore, the present invention can cope with not only a soft error caused by environmental radiations but also a soft error caused by electric or magnetic external disturbance noise or noise generated within a device.

According to the present embodiment, reconfiguration on a soft error occurrence region can be implemented without stopping a system at the time of restoration of a programmable device used in an electronic system product from a soft error caused by environmental radiations as described heretofore. As a result, reliability of systems supporting social infrastructures such as communication devices can be made high.

### REFERENCE SIGNS LIST

1: Programmable device
2: Reconfiguration control unit
3: Redundant circuit unit
4: Control circuit unit
5: Control circuit unit (duplicate of control circuit unit 4)
6: Control circuit unit (duplicate of control circuit unit 4)
7: Majority decision circuit unit
8: Clock control unit
10: Input signal selection unit
11: Tracking control unit
12: Recording data selection unit
13: State recording unit
14: Configuration control signal
15: Clock signal
16: Input signal (input signal to control circuit unit)
17: Output signal (output signal of control circuit unit)
18: Steady state clock signal
19: Clock signal used at the time of restoration from reconfiguration
20: Soft error detection signal sent from majority decision circuit to tracking control unit
21: Soft error detection signal sent from majority decision circuit to reconfiguration control unit
22: Internal state data signal sent from control circuit unit to recording data selection unit
23: Soft error detection signal sent from majority decision circuit to recording data selection unit

1. A programmable device comprising:
a plurality of control circuits;
a comparison unit for comparing outputs from the plurality of control circuits and inspecting occurrence of an error;
a storage unit responsive to determination that an error has occurred therein conducted by the comparison unit to store an internal state of a control circuit in which an error has not occurred among the plurality of control circuits;
a reconfiguration unit for reconfiguring a control circuit determined that an error has occurred therein by the comparison unit; and
a control unit for inputting the internal state of the control circuit in which an error has not occurred, stored in the storage unit, to the control circuit determined that an error has occurred therein by the comparison unit.

2. The programmable device according to claim 1, wherein the reconfiguration unit rewrites circuit information of the control circuit determined that an error has occurred therein by the comparison unit.

3. The programmable device according to claim 1, further comprising an input recording unit for recording an input signal sent from outside, wherein
the control unit inputs the input signal recorded in the input recording unit to the control circuit determined that an error has occurred therein, until the control circuit determined that an error has occurred therein catches up with a processing state in the control circuit in which an error has not occurred.

4. The programmable device according to claim 1, further comprising an error insertion unit for inserting an error signal into one of the plurality of control circuits.

5. The programmable device according to claim 1, further comprising a monitoring unit for monitoring a reconfiguration state on the basis of an error detection signal sent from the comparison unit and a reconfiguration signal sent from the reconfiguration unit.

6. An electronic device comprising:
a programmable device according to claim 1;
a processor for controlling reconfiguration conducted by the reconfiguration unit; and
a configuration data memory unit for storing a configuration data memory to be used in the reconfiguration in the reconfiguration unit.

7. A reconfiguration method in programmable device, the reconfiguration method comprising:
a comparison process in which a comparison unit compares outputs from a plurality of control circuits and inspects occurrence of an error;
a storage process in which in a case where the comparison unit determines that an error has occurred therein in the comparison process, a storage unit stores an internal state of a control circuit in which an error has not occurred among the plurality of control circuits;
a reconfiguration process in which a reconfiguration unit reconfigures a control circuit determined that an error has occurred therein in the comparison process; and
a control process in which a control unit inputs the internal state of the control circuit in which an error has not occurred, stored in the storage unit in the storage process, to the control circuit determined that an error has occurred therein in the comparison process.

8. The reconfiguration method in programmable device according to claim 7, further comprising an input recording process in which an input recording unit records an input signal sent from outside, wherein
in the control process, the control unit inputs the input signal recorded in the input recording process to the control circuit determined that an error has occurred therein, until the control circuit determined that an error has occurred therein catches up with a processing state in the control circuit in which an error has not occurred.

9. The reconfiguration method in programmable device according to claim 7, further comprising an error insertion process in which an error insertion unit inserts an error signal into one of the plurality of control circuits.

10. The reconfiguration method in programmable device according to claim 7, further comprising a monitoring process in which a monitoring unit monitors a reconfiguration state on the basis of an error detection signal which is a result of the comparison in the comparison process and a reconfiguration processing completion signal in the reconfiguration process
